(19) United States
(12) Patent Application Publication
(10) Pub. No.: US 2013/0064504 A1
(43) Pub. Date: Mar. 14, 2013

(54) PIGTAIL LIGHT GUIDE STRUCTURE

(71) Applicant: Chih-Cheng Chien, TAIPEI (TW)

(72) Inventor: Chih-Cheng Chien, TAIPEI (TW)

(73) Assignees: EZCONN CORPORATION, TAIPEI (TW); CHIH-CHENG CHIEN, TAIPEI (TW)

(21) Appl. No.: 13/232,056

(22) Filed: Sep. 14, 2011

(51) Int. Cl. G02B 6/26

(52) U.S. Cl. 385/39

(57) ABSTRACT

A pigtail light guide structure for transmitting optical signals includes an optical transmission line and a fiber stub structure. The optical transmission line has an optical fiber, a coating enclosing the optical fiber and a buffer layer enclosing the coating. A part of the optical fiber is exposed to outer side of a free end of the optical transmission line. The fiber stub structure includes a sleeve and a capillary. The sleeve has a first internal receiving hole for accommodating the optical transmission line, and a second internal receiving hole in communication with the first internal receiving hole for accommodating the capillary. The second internal receiving hole has a diameter smaller than a diameter of the first internal receiving hole. The capillary has an internal passage for accommodating a part of the optical fiber of the optical transmission line.

### BACKGROUND OF THE INVENTION

1. Field of the Invention

The present invention relates to a pigtail light guide structure.

2. Description of the Related Art

In an optical fiber communication system, optical sub-assembly for transceivers is an important medium for conversion between optical signals and electrical signals. The optical sub-assembly for transceivers can be classified into transmitting optical sub-assembly (TOSA) for transmitting optical signals, bi-direction optical sub-assembly (BOSA) capable of receiving bi-direction signals in the same optical fiber and tri-direction optical sub-assembly (TRI-DI OSA) capable of receiving both digital signals and analog signals and transmitting digital signals. Either of the TOSA, BOSA and TRI-DI OSA is connected with a pigtail light guide structure 10. Referring to FIG. 1, the pigtail light guide structure 10 includes a fiber stub structure 11 and an optical transmission line 12 coaxially disposed in the fiber stub structure 11. In general, the optical alignment between the TOSA, BOSA or TRI-DI OSA and the pigtail light guide structure 10 necessitates an X-Y-Z precision positioning stage for performing optical coupling alignment between the optical fiber 13 of the optical transmission line 12 and the light-emitting element of the TOSA, BOSA or TRI-DI OSA so as to transmit optical signals.

The fiber stub structure 11 includes a sleeve 14 and a ceramic ferrule 15 coaxially disposed in the sleeve 14 and positioned at a tail end thereof. The optical fiber 13 partially lengthwise extends into the ferrule 15.

In manufacturing process of the ferrule 15, the concentricity of the receiving hole 16 is highly required. However, the ferrule 15 is made of ceramic material. Therefore, it is quite hard to control the processing precision. As a result, the processing cost is relatively high. Moreover, the end face 17 of the ferrule 15 is surface-polished with a diamond abrasive paper. In such a manner, the surface of the end face 17 is likely to be scratched. This will cause loss to light transmission and lower signal transmission performance and need to be overcome.

### SUMMARY OF THE INVENTION

A primary object of the present invention is to provide a novel pigtail light guide structure, which is manufactured at much lower cost.

A further object of the present invention is to provide the above pigtail light guide structure, which can be easily processed.

To achieve the above and other objects, the pigtail light guide structure of the present invention includes an optical transmission line and a fiber stub structure. The fiber stub structure includes a sleeve and a capillary. The sleeve has a first internal receiving hole for accommodating the optical transmission line, and a second internal receiving hole for accommodating the capillary. The second internal receiving hole has a diameter smaller than a diameter of the first internal receiving hole. The capillary has an internal passage for accommodating a part of the optical fiber of the optical transmission line.

### BRIEF DESCRIPTION OF THE DRAWINGS

The structure and the technical means adopted by the present invent ion to achieve the above and other objects can be best understood by referring to the following detailed description of the preferred embodiments and the accompanying drawings, wherein:

FIG. 1 is a sectional view of a conventional pigtail light guide structure;

FIG. 2 is a perspective sectional view of the pigtail light guide structure of the present invention;

FIG. 3 is a sectional view of the pigtail light guide structure of the present invention;

FIG. 4 is a sectional view of the sleeve of the pigtail light guide structure of the present invention; and

FIG. 5 is a sectional view of the capillary of the pigtail light guide structure of the present invention.

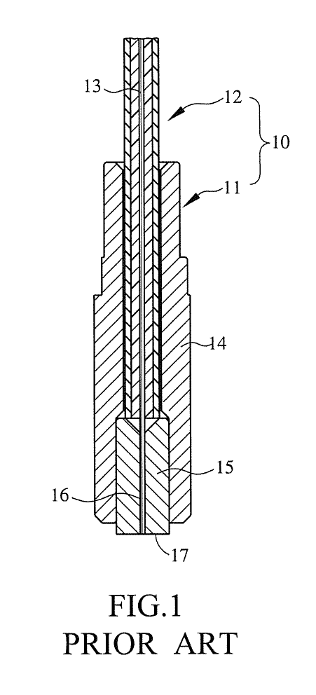

### DETAILED DESCRIPTION OF THE PREFERRED EMBODIMENT

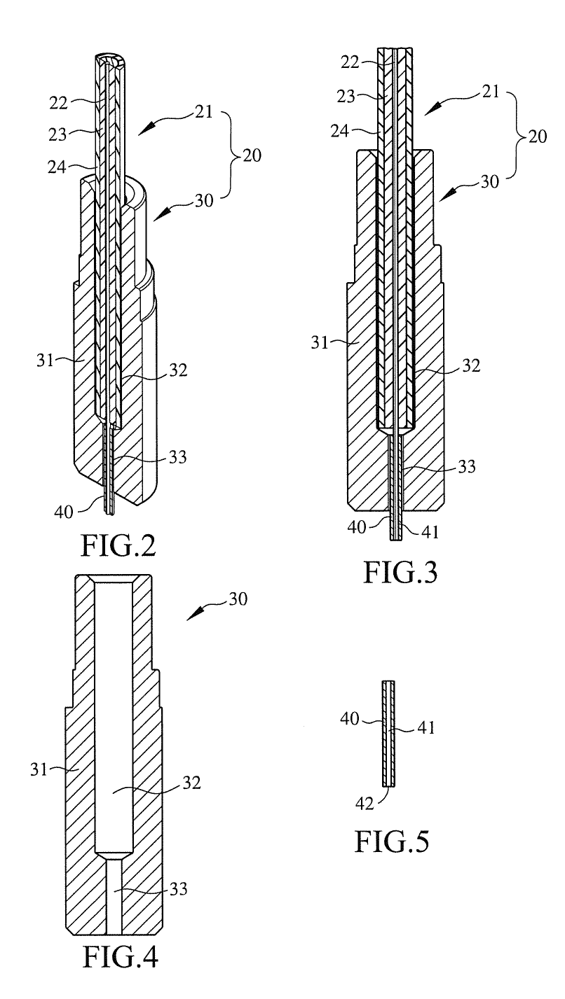

Please refer to FIGS. 2 and 3. The pigtail light guide structure 20 of the present invention includes an optical transmission line 21 and a fiber stub structure 30. The optical transmission line 21 has an optical fiber 22, a coating 23 enclosing the optical fiber 22 and a buffer layer 24 enclosing the coating 23. In practice, prior to installation of the optical transmission line 21 into the fiber stub structure 30, the coating 23 and the buffer layer 24 of a free end of the optical transmission line 21 must be partially removed to expose a part of the optical fiber 22 to outer side of the free end of the optical transmission line 21.

The fiber stub structure 30 includes a sleeve 31 and a capillary 40. As shown in FIG. 4, the sleeve 31 has a first internal receiving hole 32. The first internal receiving hole 32 has such a diameter as to accommodate the optical transmission line 21 and connect therewith. The sleeve 31 further has a second internal receiving hole 33 in communication with the first internal receiving hole 32. The second internal receiving hole 33 has such a diameter as to accommodate the capillary 40. The diameter of the second internal receiving hole 33 is smaller than the diameter of the first internal receiving hole 32.

Referring to FIG. 5, the capillary 40 has an internal passage 41, which has such a diameter as to accommodate a part of the optical fiber 22 of the optical transmission line 21. The capillary 40 is made of metal or plastic material so as to greatly lower manufacturing cost. Moreover, the end face 42 of the capillary 40 can be surface-processed by means of a conventional cutting device. The operation is simplified and speeded to quickly polish the end face 42.

The above embodiment is only used to illustrate the present invention, not intended to limit the scope thereof. It is understood that many changes or modifications of the above embodiment can be made by those who are skilled in this field without departing from the spirit of the present invention. The scope of the present invention is limited only by the appended claims.

What is claimed is:

1. A pigtail light guide structure for transmitting optical signals, comprising:
an optical transmission line having an optical fiber, a coating enclosing the optical fiber and a buffer layer enclosing the coating, a part of the optical fiber being exposed to outer side of a free end of the optical transmission line; and
a fiber stub structure including a sleeve and a capillary, the sleeve having a first internal receiving hole for accommodating the optical transmission line, and a second internal receiving hole in communication with the first internal receiving hole for accommodating the capillary, the second internal receiving hole having a diameter smaller than a diameter of the first internal receiving hole, the capillary having an internal passage for accommodating apart of the optical fiber of the optical transmission line.

2. The pigtail light guide structure as claimed in claim 1, wherein the capillary is a metal capillary.

3. The pigtail light guide structure as claimed in claim 1, wherein the capillary is a plastic capillary.
